(19) United States
(12) Patent Application Publication
(10) Pub. No.: US 2016/0080315 A1
(43) Pub. Date: Mar. 17, 2016

(54) ENHANCED DYNAMIC HOST CONFIGURATION PROTOCOL (DHCP)

(71) Applicants: Allied Telesis Holdings Kabushiki Kaisha, Tokyo (JP); ALLIED TELESIS, INC., Bothell, WA (US)

(72) Inventors: Hermin Anggawijaya, Christchurch (NZ); Theuns Willem Verwoerd, Christchurch (NZ)

(21) Appl. No.: 14/527,099

(22) Filed: Oct. 29, 2014

Related U.S. Application Data
(60) Provisional application No. 62/051,285, filed on Sep. 16, 2014.

(51) Int. Cl. H04L 29/12

(52) U.S. Cl. CPC H04L 61/2015; H04L 61/2076; H04L 61/251

(57) ABSTRACT

Systems, apparatus and methods described herein are configured for receiving a network parameter request (e.g., a DHCPv6) request from a specific client and processing the network parameter request to facilitate allocation, assignment, etc., of one or more specific network parameters to the specific client based on a unique identifier (e.g., MAC address) of the specific client. In some embodiments, the systems, apparatus and methods described herein are further configured for processing and relaying the network parameter request to a network parameter server (e.g., DHCPv6 server) to enable one or more specific network parameters to be assigned to the specific client.

### RELATED U.S. APPLICATIONS

This application claims the benefit of and priority to U.S. Provisional Patent Application No. 62/051,285, filed 16 Sep. 2014, titled “ENHANCED DYNAMIC HOST CONFIGURATION PROTOCOL (DHCP)” by Hermin Anggawijaya, et al., which is incorporated by reference herein.

### BACKGROUND

Internet Protocol version 4 (IPv4) is one addressing methodology used to route traffic across the Internet. Communication protocols may use identifiers assigned to each respective device on a communication network. The number of identifiers may be limited to certain range. For example, IPv4 uses a 32-bit address space for identifiers for devices on a communications network. Consequently, IPv4 has a limited number of identifiers available which are being rapidly exhausted. As a result a move to Internet Protocol version 6 (IPv6), which uses a much larger 128-bit address space, has begun. Unfortunately, differences between IPv6 and IPv4 create a variety of problems. For example, traditional network functions used under IPv4 may no longer work within an IPv6 network.

### SUMMARY

A need has arisen for a solution that allows assignment of network parameters based on unique device identifiers for networks using IPv6. Further, a need has arisen to have reliable and predictable unique device identifiers for assignment of IPv6 addresses where there is a relay device between a client and the server. Moreover, a need has arisen to allow IPv4 functions to be performed within IPv6 networks.

Embodiments allow assignment of one or more specific network parameters to a specific network device on an IPv6 network. Embodiments may allow assignment of specific network parameters (e.g., IP address, etc.) to a specific network device on an IPv6 network where a relay, relay agent, etc., is between the client and the Dynamic Host Configuration Protocol version 6 (DHCPv6) server. According to some embodiments information that uniquely identifies a specific client is inserted in such a way that the server can assign a stable and predictable IPv6 address to the specific client.

Embodiments may include a DHCPv6 relay agent that is topologically located between one or more clients and servers, which is configured for inserting information pertaining to a client device thereby enabling assignment of specific network parameters to a specific network device. Embodiments further allow use of both existing DHCPv6 clients and servers without modification (e.g., modification to configuration of a client, updating of server software, etc.). Embodiments thus allow the use of current server and client functionality without modification. In some embodiments, an existing parameter, variable, option, etc. is used to transmit a unique device identifier (e.g., media access control address (MAC) address) to current server configurations to be used to assign, allocate, etc., one or more specific network parameters to a specific device.

Under RFC 4580 (B. Volz, Dynamic Host Configuration Protocol for IPv6 (DHCPv6) Relay Agent Subscriber-ID Option, IETF RFC 4580, June 2006; http://tools.ietf.org/html/rfc4580.), the Subscriber-ID may be treated as an opaque value including information identifying a client. Embodiments may use the Subscriber-identifier (ID) option to carry information that uniquely identifies each client device in the form of a text-formatted MAC address derived from the source MAC address of one or more DHCPv6 packets sent by a client and intercepted by the relay agent. Embodiments may use a Remote-ID option (RFC 4649 (B. Volz, Dynamic Host Configuration Protocol for IPv6 (DHCPv6) Relay Agent Remote-ID Option, IETF RFC 4649, August 2006; http://tools.ietf.org/html/rfc4649)) to carry information that uniquely identifies each client device in the form of a text-formatted MAC address derived from the source MAC address of DHCPv6 packets sent by a client and intercepted by the relay agent. Embodiments thereby allow a DHCPv6 server to assign stable and predictable network parameters (e.g., IP address, subnet mask, gateway, etc.) to clients. For example, specific network parameters may be assigned to a specific device as the specific device is coupled at different locations to one or more networks. As another example, a student's laptop may be assigned the same IPv6 address wherever the student connects a device to a college network.

Embodiments may be used with systems that allow a Subscriber-ID to be defined on a per-port basis. Embodiments may allow a configuration to specify that a DHCPv6 relay should embed the source MAC address of a network parameter request message into the Subscriber-ID option on a specific interface. On receipt by the DHCPv6 server, the value of this option can then be used to identify the original source of a request (e.g., as an alternative to using the client-defined DHCP Unique Identifier (DUID)).

Embodiments may generate an envelope for a DHCPv6 request with the MAC address of the client embedded in the envelope in the existing Subscriber-ID option. The enveloped DHCPv6 request may then be sent to the DHCPv6 server. The server receives the envelope, accesses or receives the Subscriber-ID, maps the value in the Subscriber-ID option to one or more network parameters, and responds to the DHCPv6 request with the one or more network parameters. Embodiments thereby use a unique client identifier inserted by a relay agent to assign one or more network parameters.

An embodiment is directed to a device for facilitating network parameter assignment. The device includes an input module configured to receive a network parameter request. The network parameter request includes a unique identifier of a client device. In some embodiments, the network parameter request is a DHCPv6 request. In some embodiments, the unique identifier of the client device is a MAC address. In some embodiments, the device is a relay agent. The device further includes a processor configured to generate a data structure to send the network parameter request. The data structure includes a value set to the unique identifier of the client device. In some embodiments, the value is associated with a Subscriber-identifier (ID) parameter of the data structure. In some embodiments, the data structure is an envelope. The device further includes an output module configured to send the data structure to a network parameter server. In some embodiments, the processor is further configured to receive a response to the data structure and the data structure includes a network parameter associated with the unique identifier of the client device.

Another embodiment is directed to a device for facilitating network parameter assignment. The device includes an input module configured to receive a DHCPv6 request. The DHCPv6 request includes a unique identifier of a client device. In some embodiments, the unique identifier of the client device is MAC address. The device further includes a processor configured to generate an envelope data structure configured for sending the network parameter request to a network parameter server. The envelope data structure includes a parameter associated with the unique identifier of the client device. In some embodiments, the envelope data structure includes a unique identifier of the device. In some embodiments, the parameter is a Subscriber-identifier (ID) parameter of the envelope data structure. In some embodiments, the parameter associated with the unique identifier of the client device is in a clear text format. The device further includes an output module configured to send the data structure to the network parameter server. In some embodiments, the processor is further configured to receive a response to the envelope data structure and the response includes a network parameter associated with the unique identifier of the client device. In some embodiments, the network parameter associated with the unique identifier of the client device is an Internet Protocol (IP) address.

Another embodiment is directed to a system for facilitating network parameter assignment. The system includes a client device, a DHCPv6 server, and a relay device. The relay device includes a request receiving module configured for receiving a network parameter request. The network parameter request includes a unique device identifier and the network parameter request is a DHCPv6 request. In some embodiments, the unique device identifier is a MAC address. In some embodiments, the relay device is configured to relay the DHCPv6 request. The relay device further includes a data structure module configured for generating a data structure including the unique client identifier and a communication module configured for sending the data structure. In some embodiments, the unique device identifier is associated with a Subscriber-identifier (ID) of the data structure. In some embodiments, the communication module is configured for sending the data structure to the DHCPv6 server. In some embodiments, the communication module is configured for sending a response from the DHCPv6 server to the client device and the client device is associated with the unique device identifier.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an operating environment in accordance with some embodiments.

FIG. 2 shows communications in accordance with some embodiments.

FIG. 3 shows a flow diagram of a process for processing a network parameter request in accordance with some embodiments.

FIG. 4 shows a flow diagram of a process for facilitating assignment of specific network parameters in accordance with some embodiments.

FIG. 5 shows a block diagram of a computer system in accordance with some embodiments.

FIG. 6 shows a block diagram of another computer system in accordance with some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description of various embodiments, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits have not been described in detail as not to unnecessarily obscure aspects of the claimed embodiments.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “sending,” “querying,” “providing,” “accessing,” “associating,” “configuring,” “initiating,” “customizing”, “mapping,” “modifying,” “generating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. In some embodiments, the present systems and methods can be implemented as hardware components, e.g., an application specific integrated circuit (ASIC), a field-programmable gate array (FPGA), complex programmable logic device (CPLD), a Programmable Array Logic (PAL) device, Generic Array Logic (GAL) device, embedded device, microcontroller, programmable device, etc. Some embodiments may include a computing device, a network device, etc. configured for implementing the present systems and methods. For example, some embodiments may be implemented as a router, a switch, etc. By way of example, and not limitation, computer-readable storage media may comprise computer storage media and communication media. Generally, program modules include routines, programs, objects, components, data structures, etc., that perform specific tasks or implement specific abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

A need has arisen for a solution that allows assignment of network parameters based on unique device identifiers for networks using IPv6. Further, a need has arisen to have reliable and predictable unique device identifiers for assignment of IPv6 addresses where there is a relay device between a client and the server. Moreover, a need has arisen to allow IPv4 functions to be performed within IPv6 networks.

With dynamic host control protocol version 6 (DHCPv6), it is possible to assign a specific IPv6 address to a client based on a DHCP unique identifier (DUID) provided by a client. In DHCPv4, the unique identifier was the MAC address of the client thereby linking the unique identifier and the network interface hardware. These enabled network administrators to assign a specific IP address to a specific client device.

With migration to IPv6, one of the issues encountered by network administers, among others, is that DHCPv6 does not use the MAC address as the DUID and instead uses a DUID based on Link-layer address plus Time (DUID-LLT) generated by the operating system or concatenation of the MAC address and a timestamp. If the operating system is reinstalled, the DUID may change. If there are multiple operating systems on the machine, the operating systems may each have different DUIDs. It is further noted that the use of a timestamp in the DUID can make the DUID unpredictable. Consequently, a DHCPv6 request may not have a reliable and predictable unique identifier for use in assigning a specific set of network parameters to a specific device.

In a network architecture involving a direct connection between a DHCPv6 client and a DHCPv6 server, the DHCPv6 server may be able to identify clients using the source MAC address used by the client to send a packet to the server.

However, in network architectures having DHCPv6 clients in separate broadcast domains from the DHCPv6 server, via DHCPv6 relay agents, the ability to recognize a client by using the source MAC address is not possible. This is because the DHCPv6 packets relayed by a relay will have the source MAC address changed to the relay agent's MAC address thereby removing the client's MAC address. Thus, the ability to assign a stable and predictable IPv6 address to a given client is lost.

Some DHCPv6 clients allow setting a mode where the DUID is based on the MAC address. From an administrative point of view, it is not practical to rely on the client being configured correctly because network administrators do not necessarily have control on how DHCPv6 clients on devices connected to a network are configured.

One solution, based on the DHCPv6 RFC (R. Droms et al, Dynamic Host Configuration Protocol for IPv6 (DHCPv6), IETF RFC 3315, July 2003; http://www.ietf.org/rfc/rfc3315.txt), uses a DUID type 3, link-layer address inserted in the original client packet and is recommended only for use in devices without persistent storage. However, this requires that clients be individually configured to use that DUID type, which is problematic from an administrative standpoint.

Another solution, based on the RFC 4580 relay agent Subscriber-ID option, would extend the DHCPv6 client information to include a relay-defined Subscriber-ID. However, this would require modification of the relay agent, user configuration of a suitable Subscriber-ID for each client, and modification on the DHCPv6 server to support the relay-defined Subscriber-ID information. Unfortunately, the relay agent Subscriber-ID option would identify the network attachment point and not the client.

Another solution, based on the RFC 4649 relay agent remote-ID option, would extend the DHCPv6 client information to include a relay-defined remote ID. This would require modification to the relay agent, user configuration of a suitable remote ID for each client (or an equivalent mapping rule in DHCPv6), and modification on the DHCPv6 server to support the relay agent remote-ID option. Unfortunately, this also identifies the network attachment point and not the client.

Another solution, based on the RFC 6939 client link-layer address option in DHCPv6 (G. Halwasia et al, Client Link-Layer Address Option in DHCPv6, IETF RFC 6939, May 2003; http://tools.ietf.org/html/rfc6939), would extend the DHCPv6 client information by capturing the client link-layer address in a DHCPv6 relay option. This would require support for RFC 6939 in the DHCPv6 server and the relay agent. Unfortunately, RFC 6939 would require changes in the server and clients in order to support the client link-layer address option.

The Subscriber ID and Remote ID options may be supported by Internet Systems Consortium (ISC) DHCPv6 available from www.ipamworldwide.com/dhcp-options/isc-dhcpv6-options.html which supports RFC 6939. ISC DHCPv6 may use a hardware parameter in host records, which has been extended to attempt to match DHCPv6 clients by the last octets of a DUID link-layer or DUID-LLT provided by the client. Unfortunately, this requires a new server and does not support all DUID types. ISC DHCPv6 also adds an ignore-client-uids option in the server. This option causes the server to not record a client's UID in its lease. This violates the DHCPv6 specification but may be useful when a client can dual boot using different client ids with the same MAC address. Unfortunately, this does not work with relayed DHCP requests.

Embodiments allow assignment of one or more specific network parameters to a specific network device on an IPv6 network. Embodiments may allow assignment of specific network parameters (e.g., IP address, etc.) to a specific network device on an IPv6 network where there is a relay, relay agent, etc., between the client and the DHCPv6 server. According to some embodiments information that uniquely identifies a specific client is inserted in such a way that the server can assign a stable and predictable IPv6 address to the specific client.

Embodiments may include a DHCPv6 relay agent that is topologically located between one or more clients and servers, which is configured for inserting information pertaining to a client device thereby enabling assignment of specific network parameters to a specific network device. Embodiments further allow use of both existing DHCPv6 clients and servers without modification (e.g., modification to configuration of a client, updating of server software, etc.). Embodiments thus allow use of current server and client functionality without modification. In some embodiments, an existing parameter, variable, option, etc. is used to transmit a unique device identifier (e.g., MAC address) to current server configurations to be used to assign, allocate, etc., one or more specific network parameters to a specific device.

Under RFC 4580, the Subscriber-ID may be treated as an opaque value including information identifying a client. Embodiments may use the Subscriber-ID parameter, variable, option, etc. to carry information that uniquely identifies each client device in the form of a text-formatted MAC address derived from the source MAC address of one or more DHCPv6 packets sent by a client and intercepted by the relay agent. Embodiments may use a Remote-ID option (RFC 4649) to carry information that uniquely identifies each client device in the form of a text-formatted MAC address derived from the source MAC address of DHCPv6 packets sent by a client and intercepted by the relay agent. Embodiments thereby allow a DHCPv6 server to assign stable and predictable network parameters (e.g., IP address, subnet mask, gateway, etc.) to clients. For example, specific network parameters may be assigned to a specific device as the specific device is coupled at different locations to one or more networks. As another example, a student's laptop may be assigned the same IPv6 address wherever the student connects a device to a college network.

Embodiments may be used with systems that allow a Subscriber-ID to be defined on a per-port basis. Embodiments may allow a configuration to specify that a DHCPv6 relay should embed the source MAC address of a network parameter request message into the Subscriber-ID option on a specific interface. On receipt by the DHCPv6 server, the value of this option can then be used to identify the original source of a request (e.g., as an alternative to using the client-defined DHCP Unique Identifier (DUID)).

Embodiments may generate an envelope for a DHCPv6 request with the MAC address of the client embedded in the envelope in the existing Subscriber-ID option. The enveloped DHCPv6 request may then be sent to the DHCPv6 server. The server receives the envelope, accesses or receives the Subscriber-ID, maps the value in the Subscriber-ID option to one or more network parameters, and responds to the DHCPv6 request with the one or more network parameters. Embodiments thereby use a unique client identifier inserted by a relay agent to assign one or more network parameters.

Embodiments, for example, enable assignment of a specific IP address to a specific device thereby enabling tracking, billing, etc. As another example, embodiments may allow assignment of a specific IP address to a specific device associated with a student at a school.

Embodiments may provide enhanced security because if a unique device identifier, DUID, etc., is not known then it will be difficult for that device to function on the network. For example, a device that has a MAC address that is not registered with a DHCPv6 server within the network will not be provided with network parameters. Embodiments may further support filtering of device communications based on MAC address. For example, a specific device with a specific MAC address may be prevented from communicating with the network once the specific MAC address has been identified by a network component, DHCPv6 server, etc.

Some embodiments may provide enhanced security through limiting network access based on network parameter assignment (e.g., an IP address, a subnet mask, etc.) by a network parameter server (e.g., a DHCPv6 server). For example, embodiments may allow communication of MAC address information between a network client device and a network parameter server thereby allowing address assignment based on the network client's MAC address information. Additional filtering based on a MAC address at the network edge thereby is not needed because the determination as to whether a device is allowed to communicate on the network can be made at the network parameter server (e.g., DHCPv6 server). In some embodiments, filtering can thus be done simply on a basis of whether the network client device has been allocated an address authorized for communication with the network. In some embodiments, one or more network parameters with different authorization levels may be allocated based on network client information (e.g., a MAC address).

Various embodiments may be described with respect to IPv6 and DHCPv6 but embodiments may be configured for operating with the various other protocols. The descriptions of embodiments with respect to IPv6 and DHCPv6 are examples and are not intent to limit the scope of embodiments. It is noted that while embodiments, examples, etc., are described with respect to IPv6 and DHCPv6, embodiments are not limited to IPv6 and DHCPv6 and embodiments may work with other communication protocols.

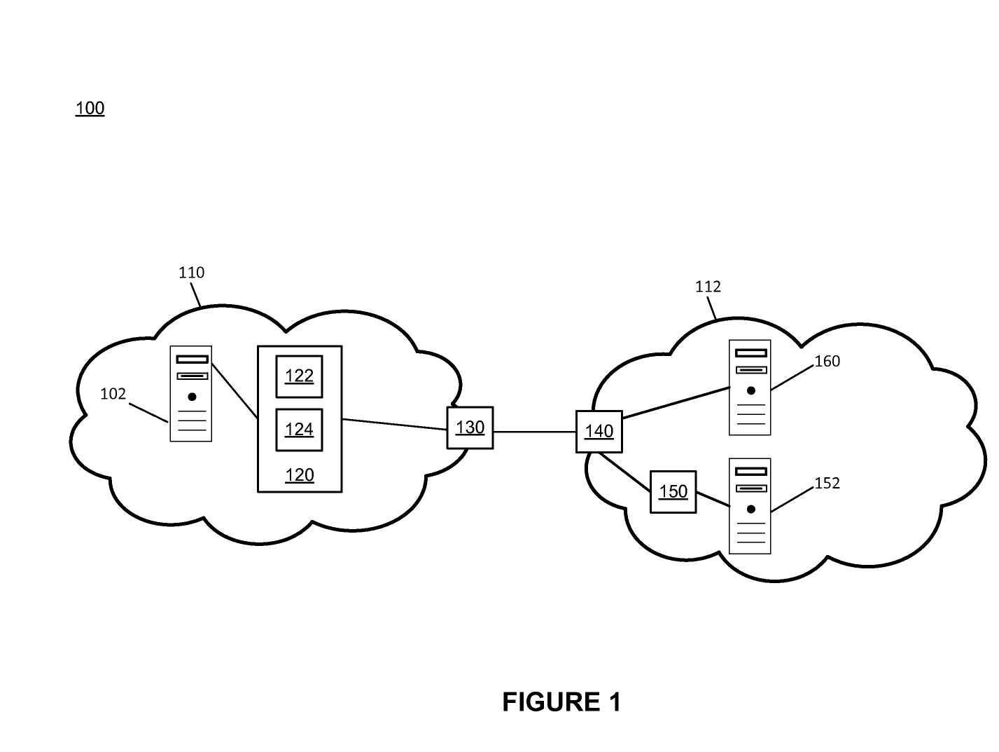

FIG. 1 shows an operating environment in accordance with some embodiments. The operating environment 100 includes networks 110 and 112, network devices 120-150, and computing devices 102, 152, and 160. Before proceeding to further describe the various components of an operating environment 100, it is appreciated that the network devices 120-150 and the computing devices 102, 152, and 160 are examples and are not intended to limit the scope of the embodiments. For example, the operating environment 100 may include other devices, such as workstations, modems, printers, bridges, switches, hubs, voice over Internet Protocol (IP) telephones, IP video cameras, computer hosts, etc. The computing devices 102, 152, and 160 may be any of a variety of computing devices including, but not limited to, computers, servers, desktop computers, laptops, tablets, mobile devices, smartphones, printers, fax machines, etc.

In some embodiments, the network 110 includes the computing device 102 and the network devices 120-130. It is appreciated that the network 110 may include more or fewer devices and the devices shown in FIG. 1 are for illustrative purposes. The computing device 102 is communicatively coupled to the network devices 120-130.

In some embodiments, the network 112 includes the computing devices 152-160 and the network devices 140-150. It is appreciated that the network 112 may include more or fewer devices and the devices shown in FIG. 1 are examples. The computing devices 152-160 are communicatively coupled to the network devices 140-150. It is appreciated that any number of computing devices (e.g., computing devices 102, 152, 160, etc.), network devices (e.g., network devices 120-150), etc., may be a part of the operating environment 100. The operating environment 100 may include more or fewer computing devices and more or fewer networking devices than shown.

The network devices 130-140 may communicatively couple the networks 110-112. The network devices 130-140 may be communicatively coupled with one or more networks in between including the Internet, a local area network (LAN), a wide area network (WAN), etc.

The network devices 120-150 may be one or more of a hub, a switch, a gateway, a router, a wireless router, a wireless access point, a camera, a thermostat, a smoke detector, etc. The network device 120-150 may perform various networking functions including Network Address Translation (NAT), Dynamic Host Control Protocol (DHCP), etc. In some embodiments, the network devices 120-140 may be routers and the network device 150 may be a switch.

In some embodiments, the network device 120 may be configured to be a DHCP relay agent. A DHCP relay agent may be any host, device, etc., which is configured to forward DHCP packets between clients and servers. In some embodiments, the computing device 102 is a client and the computing device 160 is a server. For example, the computing device 102 may be a client device, the network device 120 may be a relay device, and the computing device 160 may be a DHCPv6 server. In some embodiments, the network device 130 may be a network device configured to allow communication of network 110 with other networks (e.g., the Internet, the network 112, LANs, WANs, etc.). In some embodiments, the network devices 120-130 may be integrated as a single network device with DHCP relay functionality.

In some embodiments, the network device 120 includes an input/output module 122 and a processor 124. It is noted that the network device 120 may have additional or fewer components (e.g., a memory, a management interface, etc.). The input/output module 122 may include separate or combined input and output modules (not shown). The input/output module 122 is configured for receiving and sending network messages and communications. In some embodiments, an input module portion of the input/output module 122 is configured to receive a network parameter request, which includes a unique identifier of a client device (e.g., a MAC address). In some embodiments, the input/output module 122 may include one or more of a variety of interfaces including, but not limited to, Ethernet jacks, fiber optical jacks, etc. The processor 124 may be configured to send and receive network communications (e.g., messages, packets, etc.) and perform functions described herein to enable the functionality of embodiments, as described herein. In some embodiments, the processor 124 is configured to generate a data structure to send the network parameter request. In some embodiments, the data structure includes a value, a parameter, a variable, an option, etc. set to the unique identifier of a client. In some embodiments, an output module portion of the input/output module 122 is configured to send the data structure generated by the processor 124 to a network parameter server (e.g., a DHCPv6 server).

In some embodiments, the computing device 160 is configured as a DHCP server. The computing device 160 may thus assign, allocate, etc., network parameters to the computing devices 102 and 152. For example, the computing devices 102 and 152 may send DHCP requests to the computing device 160 for network parameters (e.g., IP address, gateway, subnet mask, etc.).

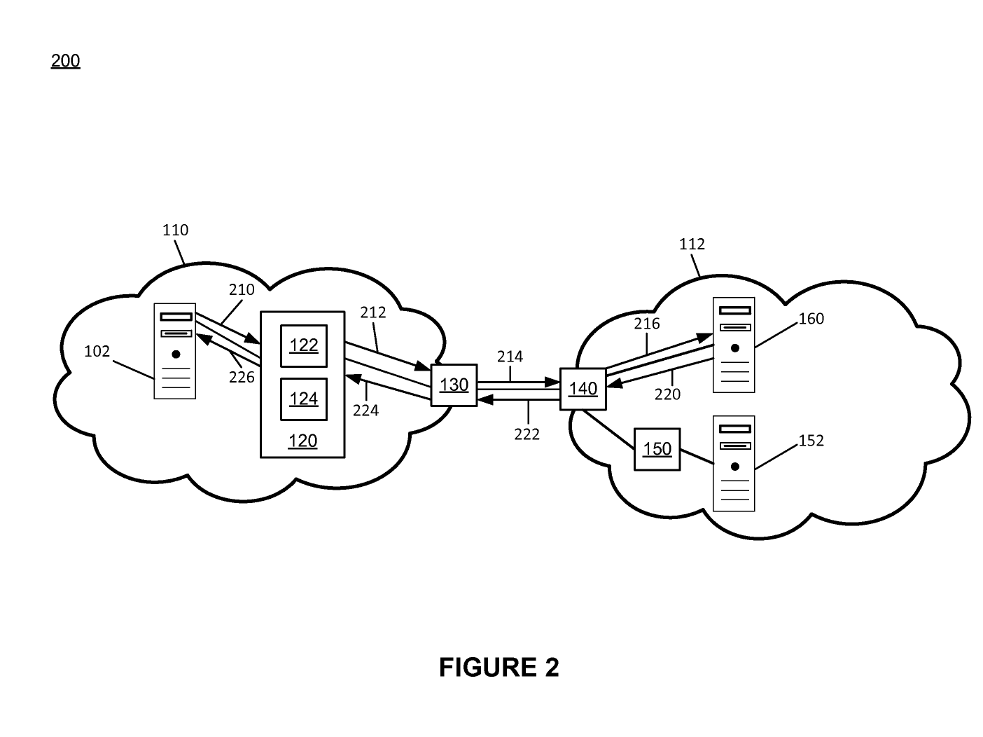

In some embodiments, the networks 110 and 112 are IPv6 networks and the computing device 160 may be configured for DHCPv6. Under IPv6, a DHCPv6 request from the computing device 152 may include an identifier (e.g., MAC address, unique identifier, etc.) that is used by the computing device 160 to assign specific network parameters (e.g., a specific IP address based on a specific identifier, a specific gateway based on a specific identifier, a specific subnet mask based on a specific identifier, etc.). Under IPv6, a DHCPv6 request from the computing device 102 may include an identifier (e.g., MAC address, unique identifier, etc.), which is removed when the network device 120, operating under conventional methods, relays the DHCPv6 request onward to the computing device 160. Embodiments described herein allow identification information to reach the computing device 160, thereby allowing the computing device 160 to assign network parameters based on an identifier of the computing device 102. In some embodiments, the network devices 130 and 140 may be relays or relay agents and include functionality for sending communications received from a relay. In some embodiments, when a communication (e.g., a data structure including a network parameter request) is received from a relay or relay agent, a unique identifier (e.g., a MAC address) of the previous relay that sent the communication is additionally stored in the communication. Embodiments are described in further detail with FIGS. 2-6.

FIG. 2 shows communications in accordance with some embodiments. Diagram 200 includes networks 110-112, network devices 120-150, and computing devices 102, 152, and 160. The communications of FIG. 2 may allow specific network parameters to be assigned, allocated, etc., to a specific computing device in an IPv6 network where a relay is between the specific computing device and a DHCP server. Elements of FIG. 2 with similar element numbers to those of FIG. 1 may operate in a substantially similar manner.

Computing device 102 may send a network parameter request message 210 to network device 120. In some embodiments, the network parameter request message 210 is a DHCPv6 request including a unique identifier associated with computing device 102 (e.g., a MAC address).

Network device 120 receives the network parameter request message 210 (e.g., via input/output module 122) and generates a data structure, an envelope, etc., (e.g., via processor 124) to be associated with a network parameter request message 212. The data structure may be configured for including and sending the network parameter request message 210. In some embodiments, the network device 120 is a DHCP relay agent. In some embodiments, the network device 120 may configure a Subscriber-ID of the envelope to a unique identifier of computing device 102. For example, the network device 120 may set the Subscriber-ID of the envelope to the MAC address of computing device 102. The network device 120 then sends the data structure as the network parameter request message 212 to the network device 130. In some embodiments, the network device 130 is a router. In some embodiments, the network device 120 is a router.

In some embodiments, commands of ip dhcp-relay agent-option, subscriber-id-auto-mac and no ip dhcp-relay agent-option subscriber-id-auto-mac may be supported. The ip dhcp-relay agent-option commands may execute in an interface context for DHCPv6 packets being relayed via the interface. When the functionality of some embodiments is configured, DHCPv6 packets being relayed on the interface may have an additional Subscriber-ID option (e.g., RFC 4580, option 38) added to the relay envelope containing the source MAC address of the original packet in hexadecimal printed format (e.g., “xxxx.xxxx.xxxx”). For example, the Subscriber-ID option may contain the source MAC address of the request frame. In some embodiments, no option is added to DHCPv6 packets (e.g., including DHCPv6 requests) that have already been relayed. The no ip dhcp-relay agent-option subscriber-id-auto-mac option removes the above mentioned setting and stops additional Subscriber-ID options from being added to packets being relayed on that interface. Return responses from the DHCPv6 server may undergo normal relay processing, including stripping off the relay envelope (including Subscriber-ID, if any).

The network device 130 receives the network parameter request message 212 and forwards the network parameter request message 212 as a network parameter request message 214 to a network device 140. In some embodiments, the network devices 130, 140 may be communicatively coupled via one or more networks (not shown) (e.g., the Internet, LAN, WAN, etc.). For example, the network 110 may be at a satellite or branch campus of a university and the network 112 may be at a main campus of the university. As another example, the network 110 may be a specific part of a campus network of a university in a specific building, area, etc., and the network 112 may be at a central information technology (IT) infrastructure portion of the university.

The network device 140 receives the network parameter request message 214 and transmits the received request as a network parameter request message 216 to the computing device 160. In some embodiments, the computing device 160 is configured as a DHCP server. For example, the computing device 160 may be configured as a DHCPv6 server.

In some embodiments, the network devices 130 and 140 may be relays or relay agents. In some embodiments, the network device 130 adds, stores, etc., a unique identifier (e.g., a MAC address) of the network device 120 to network parameter request message 214. In some embodiments, the network device 140 adds, stores, etc., a unique identifier (e.g., a MAC address) of the network device 130 to network parameter request message 216.

The computing device 160 receives the network parameter request message 216 and generates a network parameter response 220. The network parameter response message 220 may include network parameters allocated, assigned, etc., based on the identifier of computing device 102. For example, the computing device 160 may use a data store (e.g., a look up table, a database, etc.) to assign a specific IP address to a computing device 102 based on the unique identifier, e.g., MAC address, of the computing device 102 within the Subscriber-ID option of network parameter request message 216.

The computing device 160 sends the network parameter response message 220 to the network device 140. The network device 140 sends the network parameter response message 220 as a network parameter response message 222 to the network device 130. The network device 130 sends the network parameter response message 222 as network parameter response message 224 to the network device 120.

The network device 120 sends the network parameter response message 224 as a network parameter response message 226 to the computing device 102. In some embodiments, the network device 120 removes a data structure, envelope, etc., from the network parameter response message 224 prior to sending the network parameter response message 224 as a network parameter response message 226.

The computing device 102 receives the network parameter response message 226 and the computing device 102 configures itself based on the network parameters within the network parameter response message 226. Embodiments thereby allow network parameter assignment and configuration to occur based on a unique identifier of a computing device while the client device is in a different broadcast domain from the server.

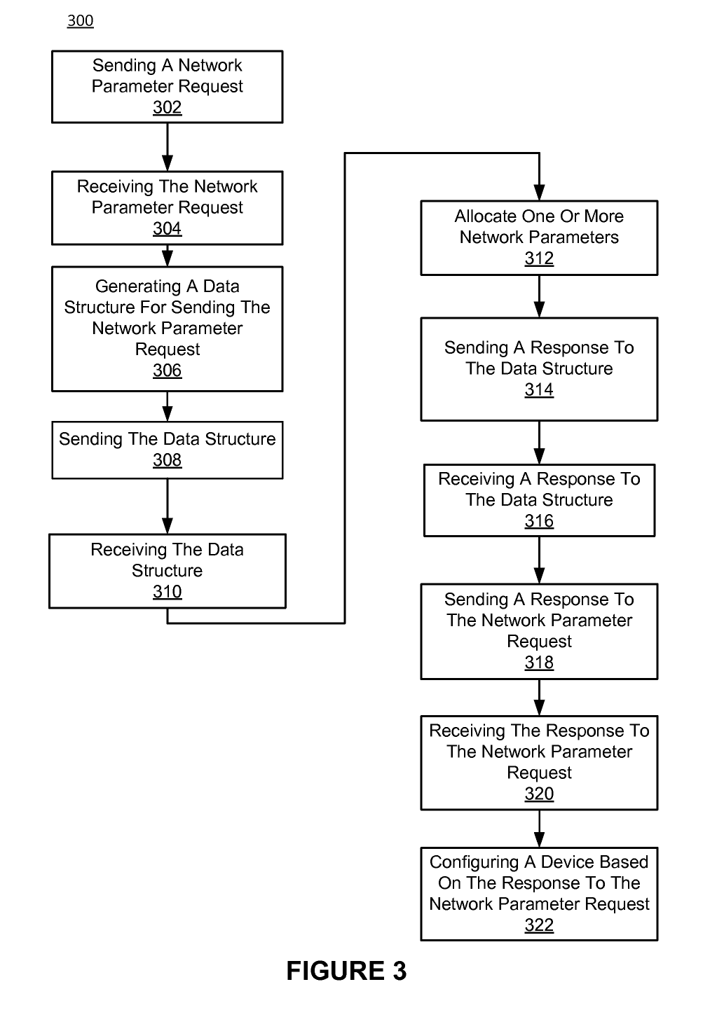

FIG. 3 shows a flow diagram of a process for processing a network parameter request in accordance with some embodiments. FIG. 3 depicts a process 300 for assignment of one or more specific network parameters to a specific device. In some embodiments, the one or more network parameters are allocated, assigned, etc., based on a unique identifier associated with the specific device on an IPv6 network, with a relay device (e.g., relay, relay agent, etc.) between the specific device and a DHCPv6 server.

At block 302, a network parameter request is sent. In some embodiments, the network parameter request is a DHCPv6 request from a client. The client may be any of a variety of computing devices, networking devices, etc., as described herein.

At block 304, the network parameter request is received. In some embodiments, the network parameter request is received by a device (e.g., an electronic system) configured to relay network parameter requests, which may include a router, a switch, etc., as described herein. In some embodiments, the device that receives the network parameter request may identify the request as a DHCPv6 request and processes the network parameter request based on process 300 accordingly.

At block 306, a data structure for sending the network parameter request is generated. In some embodiments, a data structure is generated that is configured for transporting, sending, etc., the network parameter request to a network parameter server (e.g., across one or more networks). The data structure may include a unique device identifier, e.g., a MAC address, associated with the client device that originated the network parameter request. In some embodiments, the data structure is an envelope which wraps the request in another header which is used to route the data structure to a DHCP server. In some embodiments, the relay sets the source MAC address of the envelope to the MAC address of the relay and a portion of the envelope to the MAC address of the client that originated the network parameter request. In some embodiments, the data structure has one or more parameters, variables, options, etc. that may be configured with associated values. In some embodiments, the MAC address of the client that originated the network parameter request is inserted as the Subscriber-ID value in the envelope. For example, the data structure may have a Subscriber-ID option, which has the value set to the MAC address of the client device that originated the network parameter request.

At block 308, the data structure is sent. In some embodiments, the device configured as a relay sends the data structure to a device that is closer to the network parameter server or directly to the network parameter server. The data structure may be sent through one or more devices (e.g., routers, switches, etc.) on the way to reaching the network parameter server. For example, the data structure may be sent through multiple relays on its way to the network parameter server.

In some embodiments, the data structure may be sent to another relay (e.g., a relay that is closer to the network parameter server). In some embodiments, when a communication (e.g., including a network parameter request) is received from a relay or relay agent, a unique identifier (e.g., a MAC address) of the previous relay that sent the communication is additionally stored in the communication and the communication is sent on to another relay or to the network parameter server.

At block 310, the data structure is received. In some embodiments, the device receiving the data structure is the network parameter server. For the example, the data structure may be received by a DHCPv6 server.

At block 312, data in the data structure is used to allocate network parameters (e.g., IP address, subnet mask, gateway, etc.). In some embodiments, the network parameter server receives the Subscriber-ID and matches the value of the Subscriber-ID option with a mapping of a MAC address associated with specific network parameters. For example, the MAC address may be matched via a lookup table which has pairs of IP addresses and MAC addresses. Thus, an IP address may be allocated based on a MAC address. In some embodiments, the DHCPv6 server may be configured with a data store, which has a unique device identifier, DUID, etc., associated with one or more network parameters. For example, the DHCPv6 server may have a data store with specific IP addresses associated with specific MAC addresses.

In some embodiments, the server uses the Subscriber-ID in a similar manner to IPv4 to map the value in the Subscriber-ID to network parameters because an IPv6 relay, according to some embodiments, preserves the unique identifier of the client (e.g., MAC address). Embodiments thus may function without modification to the server while allowing assignment of specific network parameters based on unique device identifiers.

At block 314, a response to the data structure is sent. In some embodiments, the network parameter server sends a response to the data structure that includes one or more of the allocated, assigned, etc., network parameters.

At block 316, a response to the data structure is received. In some embodiments, the device configured as a relay receives the response to the data structure including the one or more allocated, assigned, etc., network parameters.

At block 318, a response to the network parameter request is sent. In some embodiments, the device configured as a relay may remove portions of the data structure (e.g., envelope, etc.) and send a response to the network parameter request including the one or more allocated, assigned, etc., network parameters to the computing device, client, etc. that originated the network parameter request.

At block 320, the response to the network parameter request is received. In some embodiments, the response to the network parameter request is received by the client that originated the network parameter request.

At block 322, a device is configured based on the response to the network parameter request. In some embodiments, the device that originated the network parameter request configures itself based on the one or more allocated, assigned, etc., network parameters of the response to the network parameter request.

Embodiments thus support the association of a unique device identifier or DUID with network parameters before the device is coupled to the network. For example, a MAC address of a device may be associated with a specific IP address and three weeks later when the device is coupled to the network, the specific IP address will be allocated and/or assigned to the device upon request network parameters. As another example, a specific IP address may be assigned to a specific device irrespective of where the device is coupled or located within the network. Embodiments further allow use of both existing DHCPv6 clients and servers without modification (e.g., modification to configuration of a client, updating of server software, etc.). Embodiments thus allow use of current server and client functionality without modification. In some embodiments, an existing option is used to transmit a unique device identifier (e.g., MAC address) to current server configurations to be used to assign, allocate, etc., one or more specific network parameters to a specific device. Embodiments thus allow IPv4 functionality to be performed within an IPv6 environment or network.

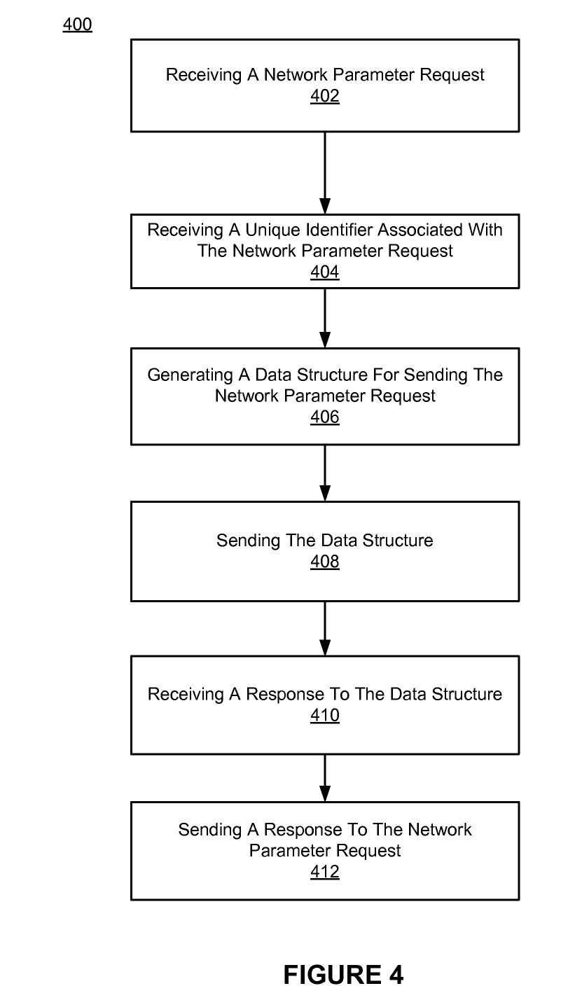

FIG. 4 shows a flow diagram of a process for facilitating assignment of specific network parameters in accordance with some embodiments. FIG. 4 depicts a process 400 of a device (e.g., a relay, relay agent, etc.) receiving a network parameter request and processing the network parameter request to enable assignment, allocation, etc., of one or more network parameters to a specific device that originated the network parameter request. For example, process 400 may be used to assign one or more specific IPv6 network parameters based on a unique identifier (e.g., MAC address) of a client that is separated from a DHCPv6 server via a relay device. In some embodiments, process 400 is performed by a device configured to relay network parameters requests (e.g., a router, switch, etc.).

At block 402, a network parameter request is received. In some embodiments, the network parameter request includes a unique identifier of a client device (e.g., a MAC address of the client), as described herein. In some embodiments, the network parameter request is a DHCPv6 request and the DHCPv6 request comprises a unique identifier of a client.

In some embodiments, the network parameter request is received at an electronic system, which may include a computing device, network device, etc., as described herein. In some embodiments, the electronic system is an electronic relay system, including a router, a switch, etc., as described herein. In some embodiments, the network parameter request is received at a relay agent.

At block 404, a unique identifier associated with the network parameter request is received, accessed, etc., as described herein. In some embodiments, the unique identifier associated with the network parameter request is received or accessed from the network parameter request and may include the MAC address of the device that originated the network parameter request.

At block 406, a data structure for sending the network parameter request is generated, as described herein. In some embodiments, the data structure comprises a value set to the unique identifier of the client. In some embodiments, the value is associated with a Subscriber-identifier (ID) option of the data structure. In some embodiments, the data structure is an envelope data structure configured for sending the network parameter request to a network parameter server. In some embodiments, the data structure is an envelope configured for sending the network parameter request across one or more networks. The envelope data structure may comprise an option associated with the unique identifier of the client. In some embodiments, the option is a Subscriber-identifier (ID) option of the envelope data structure. In some embodiments, the envelope data structure further comprises a unique identifier of the electronic relay system. In some embodiments, the option associated with the unique identifier of the client is in a clear text format.

At block 408, the data structure is sent. In some embodiments, data structure is sent to a network parameter server, as described herein. The network parameter server may be a DHCPv6 server.

At block 410, a response to the data structure is received. In some embodiments, the data structure comprises one or more network parameters associated with the unique identifier of the client. In some embodiments, a response to the envelope data structure is received and the response to the envelope data structure comprises one or more network parameters associated with the unique identifier of the client. In some embodiments, the one or more network parameters associated with the unique identifier of the client include an IP address.

At block 412, a response to the network parameter request is sent. In some embodiments, the response the network parameter request includes one or more network parameters allocated based on the unique identifier of the device that originated the network parameter request, as described herein.

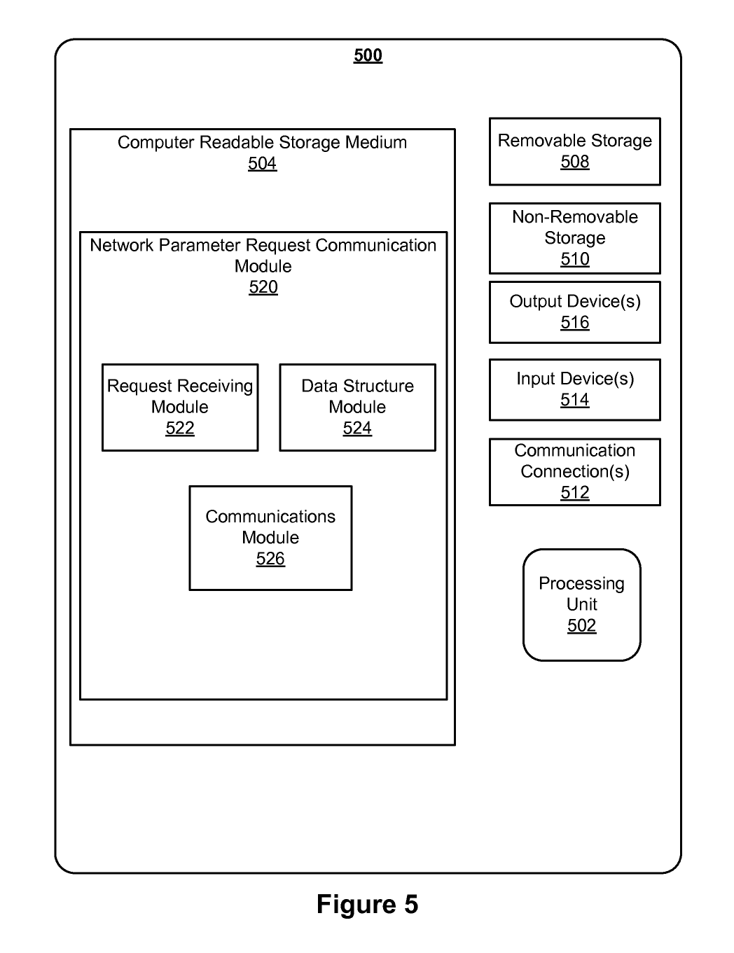

Referring now to FIG. 5, a block diagram of a computer system in accordance with some embodiments is shown. With reference to FIG. 5, an example system module for implementing embodiments disclosed above, such as the embodiments described in FIGS. 1-4. In some embodiments, the system includes a general purpose computing system environment, such as computing system environment 500. The computing system environment 500 may include, but is not limited to, servers, desktop computers, laptops, tablets, mobile devices, and smartphones. In its most basic configuration, the computing system environment 500 typically includes at least one processing unit 502 and computer readable storage medium 504. Depending on the exact configuration and type of computing system environment, computer readable storage medium 504 may be volatile (such as RAM), non-volatile (such as ROM, flash memory, etc.) or some combination of the two. Portions of computer readable storage medium 504 when executed may perform name resolution and mapping functions to allow internal or private networks to use network addresses outside of private or internal network address ranges as specified by a network protocol.

Additionally in various embodiments, the computing system environment 500 may also have other features/functionality. For example, the computing system environment 500 may also include additional storage (removable and/or non-removable) including, but not limited to, magnetic or optical disks or tape. Such additional storage is illustrated by removable storage 508 and non-removable storage 510. Computer storage media includes volatile and nonvolatile, removable and non-removable media implemented in any method or technology for storage of information such as computer readable instructions, data structures, program modules or other data. Computer readable medium 504, removable storage 508 and nonremovable storage 510 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by the computing system environment 500. Any such computer storage media may be part of the computing system environment 500.

In some embodiments, the computing system environment 500 may also contain communications connection(s) 512 that allow it to communicate with other devices. Communications connection(s) 512 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 512 may allow the computing system environment 500 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that the communication connection(s) 512 connect to may run a plurality of network protocols including, but not limited to, transmission control protocol (TCP), user datagram protocol (UDP), Internet Protocol (IP), real-time transport protocol (RTP), real-time transport control protocol (RTCP), file transfer protocol (FTP), and hypertext transfer protocol (HTTP).

In further embodiments, the computing system environment 500 may also have input device(s) 514 such as keyboard, mouse, a terminal or terminal emulator (either directly connected or remotely accessible via telnet, SSH, HTTP, SSL, etc.), pen, voice input device, touch input device, remote control, etc. Output device(s) 2016 such as a display, a terminal or terminal emulator (either directly connected or remotely accessible via telnet, SSH, HTTP, SSL, etc.), speakers, LEDs, etc. may also be included.

In some embodiments, the computer readable storage medium 504 includes a network parameter request communication module 520. The network parameter request communication module 520 is configured for receiving a network parameter request (e.g., a DHCPv6) request from a specific client and processing the network parameter request to facilitate allocation, assignment, etc., of one or more specific network parameters to the specific client based on a unique identifier (e.g., MAC address) of the specific client. The network parameter request communication module 520 includes a request receiving module 522, a data structure module 524, and a communications module 526. In some embodiments, the network parameter communication module 520 is configured to relay the DHCPv6 request.

In some embodiments, the modules may be distributed across one or more devices, including gateways, routers, name resolution devices, domain name servers, proxy devices, etc. In some embodiments, one or more of the modules may be executed, performed, etc., by a single device.

The request receiving module 522 is configured for receiving a network parameter request. In some embodiments, the network parameter request comprises a unique device identifier and the network parameter request is a DHCPv6 request. In some embodiments, the unique device identifier is a MAC address.

The data structure module 524 is configured for generating a data structure comprising the unique client identifier, as described herein. In some embodiments, the unique device identifier is associated with a Subscriber-identifier (ID) of the data structure.

The communications module 526 is configured for sending the data structure. In some embodiments, the communication module is configured for sending the data structure to a DHCPv6 server. In some embodiments, the communication module is configured for sending a response from the DHCPv6 server to a device associated with the unique device identifier.

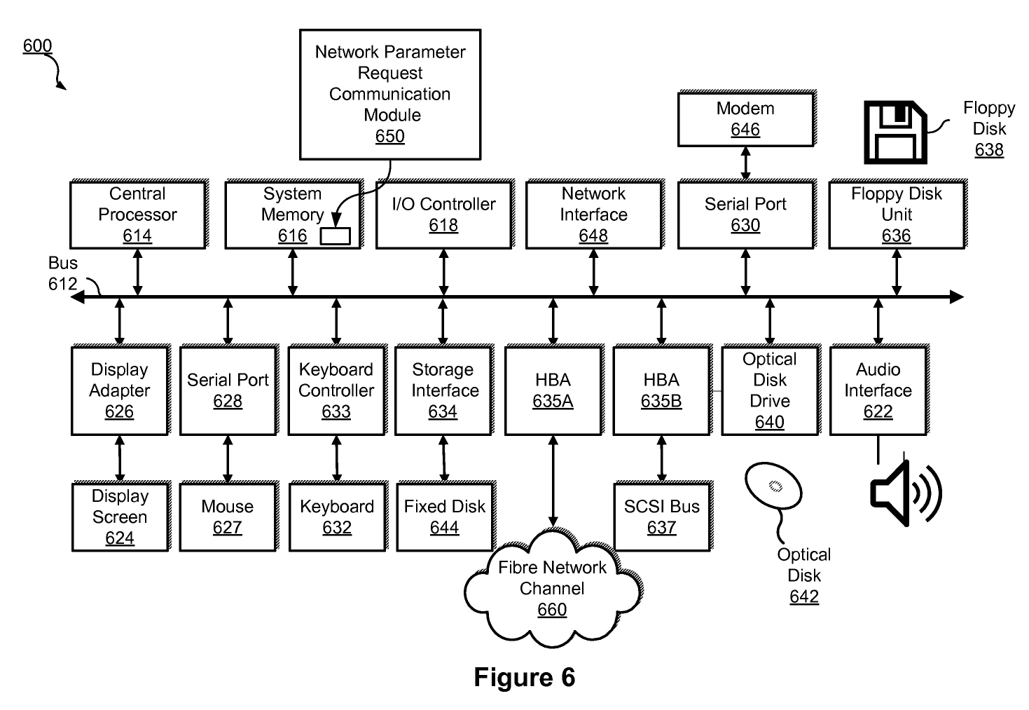

Referring now to FIG. 6, a block diagram of another computer system in accordance with some embodiments is shown. FIG. 6 depicts a block diagram of a computer system 600 suitable for implementing the present disclosure. Computer system 600 includes a bus 612 which connects the major subsystems of the computer system 600, such as a central processor 614, a system memory 616 (typically RAM, but which may also include ROM, flash RAM, or the like), an input/output controller 618, an external audio device, such as a speaker system 620 via an audio output interface 622, an external device, such as a display screen 624 via a display adapter 626, serial ports 628 and 630, a keyboard 632 (interfaced with a keyboard controller 633), a storage interface 634, a floppy disk drive 636 operative to receive a floppy disk 638, a host bus adapter (HBA) interface card 635A operative to connect with a Fibre Channel network 660, a host bus adapter (HBA) interface card 635B operative to connect to a Small Computer System Interface (SCSI) bus 637, and an optical disk drive 640 operative to receive an optical disk 642. Also included are a mouse 627 (or other point-and-click device, coupled to bus 612 via serial port 628), a modem 646 (coupled to bus 612 via serial port 630), and a network interface 648 (coupled directly to bus 612).

It is appreciated that the network interface 648 may include one or more Ethernet ports, wireless local area network (WLAN) interfaces, etc., but is not limited thereto. System memory 616 includes a network parameter request communication module 650, which is configured for receiving a network parameter request (e.g., a DHCPv6) request from a specific client and processing the network parameter request to facilitate allocation, assignment, etc., of one or more specific network parameters to the specific client based on a unique identifier (e.g., MAC address) of the specific client.

According to some embodiments, the network parameter request communication module 650 may include other modules for carrying out various tasks (e.g., modules of FIG. 5). It is appreciated that the network parameter request communication module 650 may be located anywhere in the system and is not limited to the system memory 616. As such, residing within the system memory 616 is merely an example and not intended to limit the scope of the embodiments. For example, parts of the network parameter request communication module 650 may be located within the central processor 614 and/or the network interface 648 but are not limited thereto.

The bus 612 allows data communication between the central processor 614 and the system memory 616, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 600 are generally stored on and accessed via a computer readable medium, such as a hard disk drive (e.g., fixed disk 644), an optical drive (e.g., optical drive 640), a floppy disk unit 636, or other storage medium. Additionally, applications can be in the form of electronic signals modulated in accordance with the application and data communication technology when accessed via network modem 646 or network interface 648.

The storage interface 634, as with the other storage interfaces of computer system 600, can connect to a standard computer readable medium for storage and/or retrieval of information, such as a fixed disk drive 644. A fixed disk drive 644 may be a part of computer system 600 or may be separate and accessed through other interface systems. The network interface 648 may provide multiple connections to networked devices. Furthermore, a modem 646 may provide a direct connection to a remote server via a telephone link or to the Internet via an Internet service provider (ISP). The network interface 648 provides one or more connections to a data network, which may consist of any number of other network-connected devices. The network interface 648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, not all of the devices shown in FIG. 6 need to be present to practice the present disclosure. The devices and subsystems can be interconnected in different ways than shown in FIG. 6. Code to implement the present disclosure can be stored in computer-readable storage media such as one or more of system memory 616, fixed disk 644, optical disk 642, or floppy disk 638. The operating system provided on computer system 600 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

What is claimed is:

1. A device comprising:
an input module configured to receive a network parameter request, wherein the request includes a unique identifier of a client device;
a processor configured to generate a data structure to send the network parameter request, wherein the data structure includes a value set to the unique identifier of the client device; and
an output module configured to send the data structure to a network parameter server.

2. The device as described in claim 1, wherein the network parameter request is a dynamic host control protocol version 6 (DHCPv6) request.

3. The device as described in claim 1, wherein the device is a relay agent.

4. The device as described in claim 1, wherein the data structure is an envelope.

5. The device as described in claim 1, wherein the value is associated with a Subscriber-identifier (ID) parameter of the data structure.

6. The device as described in claim 1, wherein the unique identifier of the client device is a media access control (MAC) address.

7. The device as described in claim 1, wherein the processor is further configured to receive a response to the data structure, and wherein the data structure includes a network parameter associated with the unique identifier of the client device.

8. A device comprising:
an input module configured to receive a dynamic host control protocol version 6 (DHCPv6) request, wherein the DHCPv6 request includes a unique identifier of a client device;
a processor configured to generate an envelope data structure configured for sending the network parameter request to a network parameter server, wherein the envelope data structure includes a parameter associated with the unique identifier of the client device; and
an output module configured to send the data structure to the network parameter server.

9. The device of claim 8, wherein the unique identifier of the client device is a media access control (MAC) address.

10. The device of claim 8, wherein the parameter is a Subscriber-identifier (ID) parameter of the envelope data structure.

11. The device of claim 8, wherein the envelope data structure includes a unique identifier of the device.

12. The device of claim 8, wherein the parameter associated with the unique identifier of the client device is in a clear text format.

13. The device of claim 8, wherein the processor is further configured to receive a response to the envelope data structure, and wherein the response includes a network parameter associated with the unique identifier of the client device.

14. The method of claim 13, wherein the network parameter associated with the unique identifier of the client device is an Internet Protocol (IP) address.

15. A system comprising:
a client device;
a dynamic host control protocol version 6 (DHCPv6) server; and
a relay device comprising:
a request receiving module configured for receiving a network parameter request, wherein the network parameter request includes a unique device identifier, and wherein the network parameter request is a DHCPv6 request;
a data structure module configured for generating a data structure including the unique client identifier; and
a communication module configured for sending the data structure.

16. The system of claim 15, wherein the relay device is configured to relay the DHCPv6 request.

17. The system of claim 15, wherein the unique device identifier is a media access control (MAC) address.

18. The system of claim 17, wherein the unique device identifier is associated with a Subscriber-identifier (ID) of the data structure.

19. The system of claim 15, wherein the communication module is configured for sending the data structure to the DHCPv6 server.

20. The system of claim 15, wherein the communication module is configured for sending a response from the DHCPv6 server to the client device, and wherein the client device is associated with the unique device identifier.
